(19) United States
(12) Patent Application Publication
(10) Pub. No.: US 2025/0116079 A1
(43) Pub. Date: Apr. 10, 2025

(54) BLOCKING BOLLARD COMPRISING A WARNING DEVICE, AND METHOD FOR ACTUATING A BLOCKING BOLLARD

(71) Applicant: ELKA TORANTRIEBE GMBH U. CO. BETRIEBS KG, TOENNING (DE)

(72) Inventor: TORBEN NEHLS-ELLER, MILDSTEDT (DE)

(73) Assignee: ELKA TORANTRIEBE GMBH U. CO. BETRIEBS KG, TOENNING (DE)

(21) Appl. No.: 18/834,232

(22) PCT Filed: Feb. 15, 2023
(86) PCT No.: PCT/DE2023/200032

§ 371 Date: Jul. 30, 2024

(30) Foreign Application Priority Data
Feb. 24, 2022 (DE) 10 2022 104 432.7

(51) Int. Cl. E01F 13/04; F21S 8/08; F21Y 113/00; F21Y 115/10; G08B 5/36

(52) U.S. Cl. CPC E01F 13/046; F21S 8/083; F21Y 2113/00; F21Y 2115/10; G08B 5/36

(57) ABSTRACT

A barrier bollard includes a warning device, a light source, and a barrier body arranged on a main body to be movable via a drive over a barrier height between an open and a barrier position. The light source is arranged on a lateral surface of the barrier body over a warning height in a warning region associated with an upper side of the barrier body. The light source emits an optical warning signal in an activated state. The upper side is substantially flush with the surface of the main body in the open position. In the barrier position, the upper side is moved out from the ground to project in the barrier height over the main body. The barrier body is movable for a warning sequence in a warning position where it is partially moved out from the main body and is temporarily stationary for a warning time.

### CROSS REFERENCE TO PRIOR APPLICATIONS

This application is a U.S. National Phase application under 35 U.S.C. § 371 of International Application No. PCT/DE2023/200032, filed on Feb. 15, 2023 and which claims benefit to German Patent Application No. 10 2022 104 432.7, filed on Feb. 24, 2022. The International Application was published in German on Aug. 31, 2023 as WO 2023/160759 A1 under PCT Article 21 (2).

### FIELD

The present invention relates to a barrier bollard comprising a drive, a main body, a barrier body, a warning device and a light source, wherein the main body is connectable to the ground and the barrier body is arranged on the main body movably via the drive over a barrier height in a movement direction between an open position and a barrier position, an upper side of the barrier body in the open position finishes substantially flush with a surface of the main body finishing substantially with the ground and in the barrier position projects in the barrier height over the main body and the barrier body in the barrier position is moved out from the ground and has a lateral surface arranged substantially parallel with the movement direction, wherein the light source is arranged on the lateral surface over a warning height in a warning region associated with the upper side and is configured, in an activated state, to emit an optical warning signal oriented substantially orthogonal to the movement axis. The present invention further relates to a method for actuating a barrier bollard of this kind.

### BACKGROUND

Known barrier bollards that move a barrier body via a drive relative to a main body set, for example, in the ground, often also have illumination devices for warning people, for example, car drivers. These warning devices here serve either to mark the barrier body disposed in the barrier position and/or to warn people as the barrier body is moving relative to the main body. It is thus prevented, for example, that a vehicle continues travelling in the direction of the barrier body disposed in the barrier position and is lifted and/or damaged by the barrier body.

Acoustic warning devices are also known that, for example, emit a beep or another acoustic warning signal when the barrier body is moved relative to the main body.

Corresponding warning devices with optical signals are here formed either in an upper side of the barrier body, whereby, for example, a transparent cover plate must be used which becomes scratched and/or damaged during use of the barrier bollard, or such lighting devices formed in a lateral surface of the barrier body are only visible when the barrier body executes the usually continuous movement in the direction of the barrier position via the drive.

A bollard device with display is described in DE 10 2017 006 232 A1 wherein a corresponding bollard post has an indicator device in the form of a display arranged over the full area of the lateral surface. A display of a warning sequence is here only possible when the bollard has been deployed.

EP 2 161 377 A2 describes a warning bollard. Signal lights are arranged on the warning bollard and can be connected in a flashing sequence when the column of the bollard is moved. Reflectors on the bollard are also described which provide an additional warning effect via reflection. An acoustic alarm is likewise described.

KR 1020120043413 A describes a warning bollard with rack-and-pinion drive. Warning lights are arranged in the cover face.

### SUMMARY

An aspect of the present invention is to improve upon the prior art.

In an embodiment, the present invention provides a barrier bollard which includes a drive, a main body which is connectable to the ground, a barrier body comprising an upper side and a lateral surface, a warning device, and a light source. The main body comprises a surface. The barrier body is arranged on the main body to be movable via the drive over a barrier height in a movement direction between an open position and a barrier position. The light source is arranged on the lateral surface of the barrier body over a warning height in a warning region which is associated with the upper side of the barrier body. The light source is configured, in an activated state, to emit an optical warning signal which is oriented substantially orthogonal to the movement axis. In the open position, the upper side of the barrier body is substantially flush with the surface of the main body which finishes substantially with the ground. In the barrier position, the upper side of the barrier body is moved out from the ground so as to project in the barrier height over the main body, the lateral surface of the barrier body being substantially parallel with the movement direction. The barrier body is movable in the movement direction via the drive for a warning sequence in a warning position where the barrier body is partially moved out from the main body relative to the open position and is at least temporarily stationary for a warning time, the warning position being formed so that substantially only the warning region is visible above the main body in the warning position for the warning time over the warning height, and the emission of the optical warning signal oriented substantially orthogonal to the movement axis is provided via a projection of the light source over the main body.

### BRIEF DESCRIPTION OF THE DRAWINGS

The present invention is described in greater detail below on the basis of embodiments and of the drawings in which:

FIG. 1 shows a schematic representation of a barrier bollard with a light source arrangement according to the present invention in the form of an annular LED strip;

FIG. 2 shows an isometric view of the barrier bollard in FIG. 1;

FIG. 3 shows an exemplary arrangement of the barrier bollard in an environment, namely, parallel to a ground level in a car park;

FIG. 4 shows a schematic sectional view of the barrier bollard with an alternative arrangement of a light source and a lightguide ring in an open position; and

FIG. 5 shows a schematic sectional view of the barrier bollard as in FIG. 4 in a warning position.

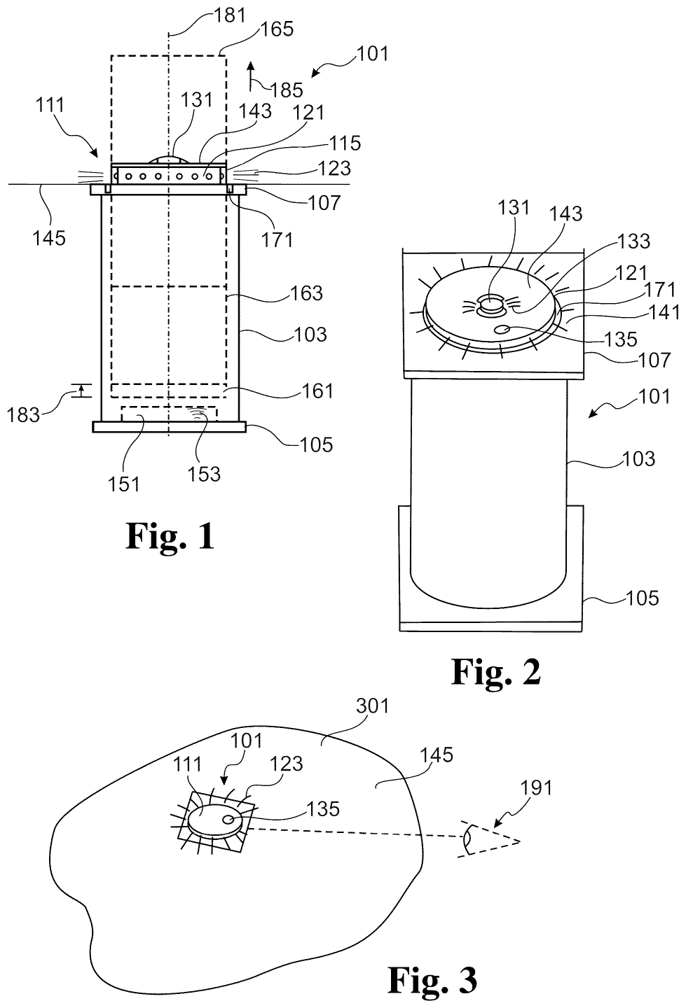

### DETAILED DESCRIPTION

The present invention provides a barrier bollard comprising a drive, a main body, a barrier body, a warning device, and a light source, wherein the main body is connectable to the ground and the barrier body is arranged on the main body movably via the drive over a barrier height in a movement direction between an open position and a barrier position, an upper side of the barrier body in the open position finishes substantially flush with a surface of the main body finishing substantially with the ground and in the barrier position projects in the barrier height over the main body and the barrier body in the barrier position is moved out from the ground and has a lateral surface arranged substantially parallel with the movement direction, wherein the light source is arranged on the lateral surface over a warning height in a warning region associated with the upper side and is configured, in an activated state, to emit an optical warning signal oriented substantially orthogonal to the movement axis, wherein the barrier body is configured movably in the movement direction via the drive for a warning sequence in a warning position that is partially moved out from the main body relative to the open position and is at least temporarily stationary for a warning time, and the warning position is formed so that substantially only the warning region is visible from above the main body in the warning position for the warning time over the warning height and the emission of the optical warning signal oriented substantially orthogonal to the movement axis is made possible merely with a projection of the light source over the main body.

The core concept of the present invention is that the activatable light source is here oriented on the lateral surface of the barrier body substantially orthogonal to the movement axis and the barrier bollard, prior to the actual deployment into the barrier position, is deployed only a short distance along the movement axis, specifically a distance that corresponds, for example, to the height of the light source on the lateral surface, and then remains initially in this warning position for a warning time. An approaching person can thus see the activated light source and recognize, for example, by the type and configuration of the optical warning signal, that the barrier bollard will, for example, be subsequently deployed. The warning height in this case is, for example, only 5 mm, only 10 mm, or only 20 mm, wherein this corresponds, for example, to just 1%, 2%, 5% or 10% of a fully deployed height in the barrier position. For example, following a warning time, the drive of the barrier bollard can then be actuated so that the barrier bollard is moved further in the direction of the barrier position so that the barrier body is transferred into the barrier position when relevant people have already been warned by the warning sequence.

The following terms should be explained in this context:

A “barrier bollard” is a mechanical device that is designed to be retractable, for example, in a “ground”, i.e., in the floor of a car park or an indoor area, in order to close off corresponding areas by moving out the barrier bollard. Such barrier bollards are used, for example, as lifting bollards to keep car parks clear or to temporarily block emergency access routes. For this purpose, such a barrier bollard has a “drive”, for example, a hydraulic, electric, or servo-electric drive, via which a corresponding “barrier body” can be moved when supported on a “main body”. The main body is, for example, a pot-like receiving device which is installed in the ground and secured, for example, via a foundation, whereas the barrier body forms a movable part of the barrier bollard which can be moved relative to the main body in a “movement direction”, for example, a substantially vertical axis. The barrier bollard has a “warning device”, i.e., a device for warning drivers and/or pedestrians, for example, wherein the warning device can in particular have optical as well as acoustic elements. The warning device in particular has a “light source”, for example, an LED strip, light points, or the like, via which light can be emitted.

The barrier bollard is characterized by a “barrier height”, along which the barrier body is arranged movably on the main body between an “open position”, i.e., a position that is substantially completely sunk into the ground, and a “barrier position” with the barrier body substantially fully deployed. An “upper side” of the barrier body is, for example, a flat side of the barrier body that is visible in the ground even in the open position and is substantially flush with a “surface” of the main body, i.e., a surface of the main body that is, for example, substantially embedded in the ground and can still be seen by a person. A “lateral surface” of the barrier body is here oriented substantially parallel to the movement direction and is, for example, cylindrical or prismatic in shape. The lateral surface is in particular a surface of the barrier body that is visible in the barrier position or partially visible during a transition from the open position to the barrier position, which also serves, for example, as a guide surface for the barrier body in the main body or has corresponding guide device for guiding the barrier body in the main body.

A “warning region” is here a partial region of the lateral surface which is in particular arranged starting from the upper side or associated with the upper side so that a “warning height”, i.e., a partial height of the lateral surface starting from the upper side, can be illuminated or marked via the light source with, for example, an optical warning signal. This “optical warning signal” is, for example, a luminous color of the light source, a luminous sequence of the light source, or a luminous sequence of the light source, which is then emitted substantially orthogonal to the movement axis, i.e., also substantially parallel to the surface and/or the ground, in order to warn a person or a driver, for example, of a vehicle. An “activated state” is here the state in which the light source actively emits light and/or, for example, a period of time in which the light source repeatedly emits a sequence of light signals.

A “warning sequence” here describes a special sequence of movements, in particular one that is essential to the present invention, during which the barrier body is partially moved out of the open position, in particular, for example, by only 1%, 2%, 5% or even 10% of the barrier height, so that an intermediate position, which is referred to as the “warning position”, between the open position and the barrier position is assumed at least temporarily over a specific, relatively short period of time of, for example, 1 second, 2 seconds, 5 seconds, 10 seconds or even 20 seconds, depending in each case on the application, which is referred to as the “warning time”. This “warning position” is in particular significantly further in the direction of the open position than in the direction of the barrier position, as mentioned above. In this warning position, substantially only the warning region in the warning position for the warning time protrudes over the warning height above the main body. The expression “substantially only” means that only an absolutely necessary height of the warning region or warning region protrudes over the main body, as only an absolutely necessary height of the partial height of the height of the barrier position, so that in particular a person is prevented from tripping in the best possible way, a car can still drive up without danger, and the light source can still emit the corresponding warning signal to warn people.

In order to be able to carry out a warning around a corresponding region around the circumference of the barrier bollard, the light source surrounds a circumference of the lateral surface over at least 90°, at least 120°, at least 180° and/or in particular substantially completely. Angle specifications here refer to full angles of 360°. In this arrangement, for example, an all-round warning signal can be emitted if the light source substantially completely surrounds the circumference of the lateral surface.

A “circumference” refers here to a partial region of the lateral surface measured around the movement direction.

In an embodiment of the present invention, the light source can, for example, be configured to emit a colored, in particular a red, a yellow and/or a blue optical warning signal and/or an optical warning signal with a freely selectable, in particular changing color.

The light source with this embodiment can be adapted to corresponding situations, applications or, for example, color concepts in the region of the ground if, for example, the barrier bollard is to be integrated into an existing color concept in front of a building.

In order to minimize the power consumption of the barrier bollard, the light source has one LED, several LEDs and/or an LED strip and/or a lightguide device, wherein the lightguide device is set up in particular for guiding the optical warning signal emitted by the light source in a direction substantially parallel to the movement direction, in particular for generating a secondary warning signal.

A “lightguide device” is in this case in particular a translucent element which is set up to guide light at interfaces via total reflection and which is arranged, for example, in the form of a ring or a partial ring around the circumference of the barrier body and is embedded or partially embedded in the surface of the main body so that, for example, when the light source is actuated to emit a warning signal as a secondary warning signal via the same light source, additional marking in the region of the substrate is already possible while the warning position is being assumed. For this purpose, the lightguide device has an overlap with the light source along the movement direction, which is present, for example, in the open position and, by the positioning and design of the lightguide device, is in particular maintained until the warning position is partially or completely reached.

In an embodiment of the present invention, the lightguide device can, for example, be formed in particular from a translucent material and designed as a lightguide ring, wherein the lightguide ring is associated with the surface of the main body in the open position, in particular flush with the surface of the main body, and at least partially surrounds the circumference of the barrier body, wherein the optical warning signal emitted by the light source into the lightguide ring is deflected in the direction of the upper side towards the upper side so that the optical warning signal on the upper side is additionally recognizable in the open position, in particular as a secondary warning signal.

A “lightguide ring” is here in particular an annular translucent optical active body that completely or partially surrounds the circumference of the lateral surface, which thus enables, for example, an annular or partially annular transmission of the optical warning signal in the direction of the upper side.

In order to achieve an additional warning effect, an acoustic signaling device is associated with the warning device, wherein the acoustic signaling device enables an acoustic signal to be emitted.

The “acoustic signaling device” is in this case, for example, a loudspeaker or another sound-emitting device, wherein an “acoustic warning signal”, i.e., for example, a warning tone, a beep or a sound sequence, for example, with a fixed melody, can be emitted.

In an embodiment of the present invention, an additional light source can, for example, be associated with the warning device on the upper side, wherein the additional light source is set up to emit an additional optical warning signal on the upper side, in particular to emit the optical warning signal in a direction substantially orthogonal to the movement direction.

The warning time is in particular more than 5 seconds, more than 10 seconds, more than 20 seconds, or more than 30 seconds.

In a further aspect, the present invention provides a method for actuating a barrier bollard according to one of the previously described embodiments with a warning sequence for warning persons in a warning time, the method having the following steps:
moving the barrier body in the movement direction via the drive from the open position to the warning position;
activating the light source so that the optical warning signal is emitted via the light source of the warning device in the warning sequence over the warning time and substantially only the warning region is visible in the warning position for the warning time over the warning height above the main body, and the optical warning signal, which is substantially orthogonal to the movement axis, is emitted in the warning position with a projection of the light source over the main body over the warning height; and
moving the barrier body in the movement direction via the drive from the warning position to the barrier position so that the barrier body is moved to the barrier height in the barrier position,
so that the barrier bollard is actuated with the warning sequence for warning people in a warning time.

In an embodiment of the present invention, the light source can, for example, be activated before the barrier body is moved into the warning position and/or before the barrier position is reached, in particular in the open position and/or after the barrier body has been moved into the open position, so that the optical warning signal can be recognized from the upper side via the lightguide device, in particular before the actual warning sequence is visible.

The present invention is explained in greater detail below with reference to exemplary embodiments as described in the drawings.

A barrier bollard 101 has a main body 103 which is cylindrical in shape. The main body 103 has a base plate 105 and a cover 107, wherein the cover 107 is embedded in a ground level 14 so that a surface 141 of the cover 107 is arranged parallel to the ground level 145. The base plate 105 here serves to seal the main body 103 with respect to the ground and, together with the main body 103, also to secure the barrier bollard 101 in the ground, for example, in a foundation.

A likewise cylindrical barrier body 111 is arranged within the main body 103 and is embodied as a bollard that can be moved out of the ground level 145. The barrier body 111 has an upper side 143, which is flush with the surface 141 in an open position 161, wherein the barrier body 111 is recessed in the main body 103 in the barrier position 165. The barrier body 111 has an LED ring 121 directly near the upper side 143 on a lateral surface 115, i.e., substantially orthogonal to the upper side 143, which LED ring 121 is formed from an LED strip which is arranged in a ring on the lateral surface and which can emit an optical warning signal 123. According to the present invention, the barrier body 111 is moved from the open position 161 by a path 183 along a movement axis 181 in the direction of a warning position 163 so that only the LED ring 121 is arranged above the surface 141 and thus above the ground level 145. The warning signal 123 is then visible with the smallest possible projection of the barrier body 111 above the surface 141 so that an excessive risk of tripping or even a risk of collision for a vehicle is greatly reduced or even avoided. The upper side 143 as well as the surface 141 of the cover 107 are made of stainless steel and are therefore scratch-resistant and thus less susceptible to wear. These components can also be made of steel, cast steel or another scratch-resistant material. Only after a warning time has elapsed, for example, 5 seconds or even 10 seconds, does the barrier body 111 then move along a path 185 into a barrier position 165, i.e., completely out of the ground level 145. An emergency access 135 serves as access for emergency unlocking depending on the drive concept (which is only shown by way of example).

To perform the corresponding functions, the barrier bollard 101 has a drive technology 151, shown by way of example, which comprises a control board (not shown), an electric drive (not shown) for the barrier bollard 101 for moving the barrier body 111, and also a loudspeaker 153 for emitting an additional acoustic warning signal. It should here be mentioned that, depending on the embodiment of the barrier bollard 101, a corresponding loudspeaker can also be arranged in the so-called “head” of the barrier bollard 101, for example, protected from external influences below the upper side 143 of the barrier body 111. The control board controls both the drive and the functions of the LED ring 121, additional lighting, and also the loudspeaker 153. An auxiliary light 131 can optionally and additionally be attached to the upper side 143 of the barrier body 111 and can emit an additional warning signal 133. This auxiliary light 131 can be used, for example, to emit an additional warning signal before the warning signal 123 can be perceived.

In addition to the LED ring 121, a lightguide ring 171 made of a translucent, i.e., a transparent and light-conducting material, which in the shown example is made of glass, is embedded around the circumference of the barrier body 111 in the cover 107 for its protection, slightly recessed relative to the upper side 143 and the surface 141, which already in the open position 161 deflects the warning signal 123 from the LED ring 121 in a direction parallel to the movement axis 181 so that the warning signal 123 is recognizable even when the barrier body 111 is fully recessed. For this purpose, the light from the LED ring 121 is picked up laterally, i.e., orthogonally to the movement axis 181, and is deflected by light conduction so that the warning signal 123 is emitted in a direction parallel to the movement axis 181 as long as the barrier body 111 is in the open position 161. The warning signal 123 can thus be activated even before the transfer to the warning position 163 and can act as an advance warning.

For example, an eye 191 of a standing person (person not shown) observes the corresponding barrier bollard 101 in a car park 301 so that the warning signal 123 can be seen at the latest after the barrier bollard 101 has been moved into the warning position 163, and the barrier body 111 only protrudes so far above the surface of the car park 301, namely, above the ground level 145, that there is no excessive risk of tripping and also no risk of impact for vehicles and the barrier bollard 101 can be seen at an early stage. If the warning signal 123 is already activated when the barrier body 111 is still in the open position 161, the person can already see the warning signal 123 from the ground level 145 in the car park and be warned, for example, by a yellow flashing signal, that the barrier body 111 is to be deployed. It should be mentioned by way of example that the corresponding warning signal 123 and/or also the additional warning signal 133 can be actuated via the drive technology 151, for example, in different colors, different frequencies, or also corresponding sequences of, for example, color changes.

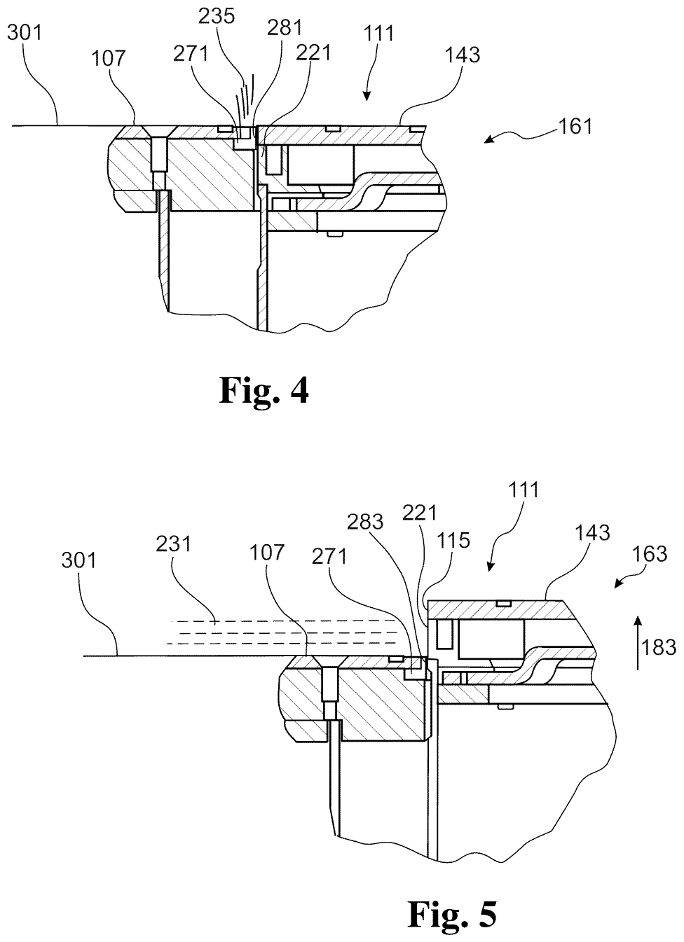

In an alternative embodiment (compare FIGS. 4 and 5), the barrier body 111 has a light strip 221 which is arranged in an upper region of the lateral surface 115 over the entire area around the circumference of the barrier body 111 and can emit a warning signal 231 parallel to the car park 301 via LEDs. If the barrier body 111 is still in the open position 161, however, the light of the warning signal is redirected along the movement axis 181 from a direction parallel to the cover 107 to a direction substantially orthogonal to the cover 107 via an overlap 281 of the light strip 221 with a lightguide ring 271 and appears as an advance warning signal 235 visible from above. The lightguide ring 271 can also be designed via a matt surface so that a diffuse advance warning signal 23 is generated which does not have an exclusive orientation. As soon as the barrier body 111 is moved around the path 183 into the warning position 163, a continued overlap 283 between the light strip 221 and the lightguide ring 271 provides that the advance warning signal 235 remains visible and is supported by the warning signal 231, which is then visible, and is replaced by the warning signal 231 as the barrier body 111 continues to move along the path 185 into the barrier position 165. It is consequently possible to warn people at any time, even in the region of the open position 161, only by using the light strip 221 as a light source. It should here be mentioned that the lightguide ring 271 with an appropriate choice of material and hardness, for example, can also act as a dirt wiper ring with respect to the barrier body 111.

The present invention is not limited to embodiments described herein; reference should be had to the appended claims.

### LIST OF REFERENCE NUMERALS

101 barrier bollard
103 main body
105 base plate
107 cover
111 barrier body
115 lateral surface
121 LED ring
123 warning signal
131 auxiliary light
133 additional warning signal
135 emergency access
141 surface
143 upper side
145 ground level
151 drive technology
153 loudspeaker
161 open position
163 warning position
165 barrier position
171 lightguide ring
181 movement axis
183 path
185 path
191 eye
221 light strip
231 warning signal
235 advance warning signal
271 lightguide ring
281 overlap
283 continued overlap
301 car park

What is claimed is:

1-10. (canceled)

11. A barrier bollard comprising:
a drive;
a main body which is connectable to the ground, the main body comprising a surface;
a barrier body comprising an upper side and a lateral surface, the barrier body being arranged on the main body to be movable via the drive over a barrier height in a movement direction between an open position and a barrier position;
a warning device; and
a light source which is arranged on the lateral surface of the barrier body over a warning height in a warning region which is associated with the upper side of the barrier body, the light source being configured, in an activated state, to emit an optical warning signal which is oriented substantially orthogonal to the movement axis,
wherein,
in the open position, the upper side of the barrier body is substantially flush with the surface of the main body which finishes substantially with the ground,
in the barrier position, the upper side of the barrier body is moved out from the ground so as to project in the barrier height over the main body, the lateral surface of the barrier body being substantially parallel with the movement direction, and
the barrier body is movable in the movement direction via the drive for a warning sequence in a warning position where the barrier body is partially moved out from the main body relative to the open position and is at least temporarily stationary for a warning time, the warning position being formed so that substantially only the warning region is visible above the main body in the warning position for the warning time over the warning height, and the emission of the optical warning signal oriented substantially orthogonal to the movement axis is provided via a projection of the light source over the main body.

12. The barrier bollard as recited in claim 11, wherein the light source surrounds a circumference of the lateral surface over at least 90°.

13. The barrier bollard as recited in claim 12, wherein the light source surrounds the circumference of the lateral surface over from at least 90° to substantially 360°.

14. The barrier bollard as recited in claim 11, wherein the light source is further configured to emit at least one of a colored warning signal and an optical warning signal with a freely selectable color.

15. The barrier bollard as recited in claim 14, wherein,
the colored warning signal is at least one of a red optical warning signal, a yellow optical warning signal and a blue optical warning signal, and
the freely selectable color of the optical warning signal comprises a changing color.

16. The barrier bollard as recited in claim 11, further comprising:
an acoustic signaling device which is associated with the warning device, the acoustic signaling device being configured to enable an acoustic warning signal to be emitted.

17. The barrier bollard as recited in claim 11, further comprising:
an additional light source which is associated with the warning device on the upper side, the additional light source being configured to emit an additional optical warning signal on the upper side.

18. The barrier bollard as recited in claim 17, wherein the additional light source is further configured to emit the additional optical warning signal in a direction which is substantially orthogonal to the movement direction.

19. The barrier bollard as recited in claim 11, wherein the warning time is more than 5 seconds.

20. The barrier bollard as recited in claim 11, wherein the light source comprises at last one of one LED, several LEDs, an LED strip, and a lightguide device.

21. The barrier bollard as recited in claim 20, wherein the lightguide device is arranged to guide the optical warning signal which is emitted by the light source in a direction which is substantially parallel to the movement direction.

22. The barrier bollard as recited in claim 21, wherein the lightguide device generates a secondary warning signal.

23. The barrier bollard as recited in claim 20, wherein,
the lightguide device comprises a lightguide ring which is associated with the surface of the main body in the open position and at least partially surrounds a circumference of the barrier body, and
the optical warning signal emitted by the light source is emitted into the lightguide ring and is there deflected in a direction of the upper side towards the upper side, so that the optical warning signal on the upper side is additionally recognizable in the open position.

24. The barrier bollard as recited in claim 23, wherein,
the lightguide ring is formed from a translucent material, and
the lightguide ring which is associated with the surface of the main body in the open position is arranged to be flush with the surface of the main body.

25. A method for actuating the barrier bollard as recited in claim 20 with a warning sequence for warning people in a warning time, the method comprising:
moving the barrier body in the movement direction via the drive from the open position to the warning position;
activating the light source so that the optical warning signal is emitted via the light source of the warning device in the warning sequence over the warning time so that substantially only the warning region is visible in the warning position for the warning time over the warning height above the main body, and the optical warning signal, which is oriented substantially orthogonal to the movement axis, is emitted in the warning position with a projection of the light source over the main body over the warning height; and
moving the barrier body in the movement direction via the drive from the warning position to the barrier position so that the barrier body is moved to the barrier height in the barrier position,
to thereby actuate the barrier bollard with the warning sequence for the warning people in the warning time.

26. The method as recited in claim 25, wherein the activating of the light source is performed at least one of,
before the moving of the barrier body to the warning position,
before the barrier body has reached the barrier position, and
after the barrier body has been moved into the open position,
so that the optical warning signal can be recognized from the upper side via the lightguide device.

27. The method as recited in claim 26, wherein the activating of the light source is performed in the open position before the barrier body has reached the barrier position.
